(19) United States
(12) Patent Application Publication
(10) Pub. No.: US 2025/0252858 A1
(43) Pub. Date: Aug. 7, 2025

(54) CONTROL DEVICE, METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Akira HIROTA, Anjo-shi Aichi-ken (JP); Takashi SAKUI, Nagoya-shi Aichi-ken (JP); Keisuke SUGINO, Nagakute-shi Aichi-ken (JP); Masamichi KUWAJIMA, Nagoya-shi Aichi-ken (JP); Masashi HISATOMI, Nagakute-shi Aichi-ken (JP); Yasuhiro KOBATAKE, Nagoya-shi Aichi-ken (JP); Takahiro TANAKA, Shibuya-ku Tokyo (JP)

(73) Assignee: TOYOTA JIDOSHA KABUSHIKI KAISHA, Toyota-shi Aichi-ken (JP)

(21) Appl. No.: 18/989,611

(22) Filed: Dec. 20, 2024

(30) Foreign Application Priority Data
Feb. 7, 2024 (JP) 2024-017494

(51) Int. Cl. G08G 5/54; G08G 5/26; G08G 5/72; G08G 5/76

(52) U.S. Cl. CPC G08G 5/54; G08G 5/26; G08G 5/727; G08G 5/76

(57) ABSTRACT

A control device includes a storage unit, a communication unit configured to communicate with a vertical take-off and landing aircraft, and a control unit. The control unit is configured to: when a landing request is received from the vertical take-off and landing aircraft via the communication unit, determine whether the vertical take-off and landing aircraft is adapted to a runway landing; and when the vertical take-off and landing aircraft is adapted to the runway landing, acquire reference information indicating an environment for landing of the vertical take-off and landing aircraft, and transmit an instruction to the vertical take-off and landing aircraft to land in one landing mode out of a vertical landing and the runway landing based on the reference information.

### CROSS-REFERENCE TO RELATED APPLICATION

This application claims priority to Japanese Patent Application No. 2024-017494 filed on Feb. 7, 2024, incorporated herein by reference in its entirety.

### BACKGROUND

### 1. Technical Field

The present disclosure relates to a control device, a method, and a non-transitory storage medium.

### 2. Description of Related Art

Hitherto, there are flight vehicles having a vertical take-off and landing function. For example, Japanese Unexamined Patent Application Publication No. 2023-000617 (JP 2023-000617 A) discloses a flight vehicle that makes a vertical landing at an airport in response to landing permission from a flight vehicle operation management system.

### SUMMARY

When a vertical take-off and landing aircraft is adapted to a plurality of landing modes including not only a vertical landing but also a runway landing, there is room for improvement in technology that allows the aircraft to land in a more appropriate landing mode depending on the situation.

A first aspect of the present disclosure relates to a control device including a storage unit, a communication unit configured to communicate with a vertical take-off and landing aircraft, and a control unit. The control unit is configured to: when a landing request is received from the vertical take-off and landing aircraft via the communication unit, determine whether the vertical take-off and landing aircraft is adapted to a runway landing; and when the vertical take-off and landing aircraft is adapted to the runway landing, acquire reference information indicating an environment for landing of the vertical take-off and landing aircraft, and transmit an instruction to the vertical take-off and landing aircraft to land in one landing mode out of a vertical landing and the runway landing based on the acquired reference information.

A second aspect of the present disclosure relates to a method to be executed by a control device including a storage unit, a communication unit configured to communicate with a vertical take-off and landing aircraft, and a control unit. The method includes: when a landing request is received from the vertical take-off and landing aircraft via the communication unit, determining, by the control unit, whether the vertical take-off and landing aircraft is adapted to a runway landing; and when the vertical take-off and landing aircraft is adapted to the runway landing, acquiring, by the control unit, reference information indicating an environment for landing of the vertical take-off and landing aircraft, and transmitting an instruction to the vertical take-off and landing aircraft to land in one landing mode out of a vertical landing and the runway landing based on the acquired reference information.

A third aspect of the present disclosure relates to a non-transitory storage medium storing instructions that are executable by one or more processors and that cause the one or more processors to perform functions. The functions include: when a landing request is received from a vertical take-off and landing aircraft via a communication unit, determining whether the vertical take-off and landing aircraft is adapted to a runway landing; when the vertical take-off and landing aircraft is adapted to the runway landing, acquiring reference information indicating an environment for landing of the vertical take-off and landing aircraft; and transmitting an instruction to the vertical take-off and landing aircraft to land in one landing mode out of a vertical landing and the runway landing based on the acquired reference information.

According to the present disclosure, it is possible to improve the technology that allows the vertical take-off and landing aircraft adapted to a plurality of landing modes to land in a more appropriate landing mode depending on the situation when the aircraft makes a landing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a flowchart showing operations of the system according to the embodiment; and

FIG. 3 is a flowchart showing operations of the system according to a modification.

### DETAILED DESCRIPTION OF EMBODIMENTS

Hereinafter, an embodiment of the present disclosure will be described below with reference to the drawings. In each drawing, the same or corresponding parts are denoted by the same reference signs. In the present embodiment, description of the same or corresponding parts will be omitted or simplified as appropriate.

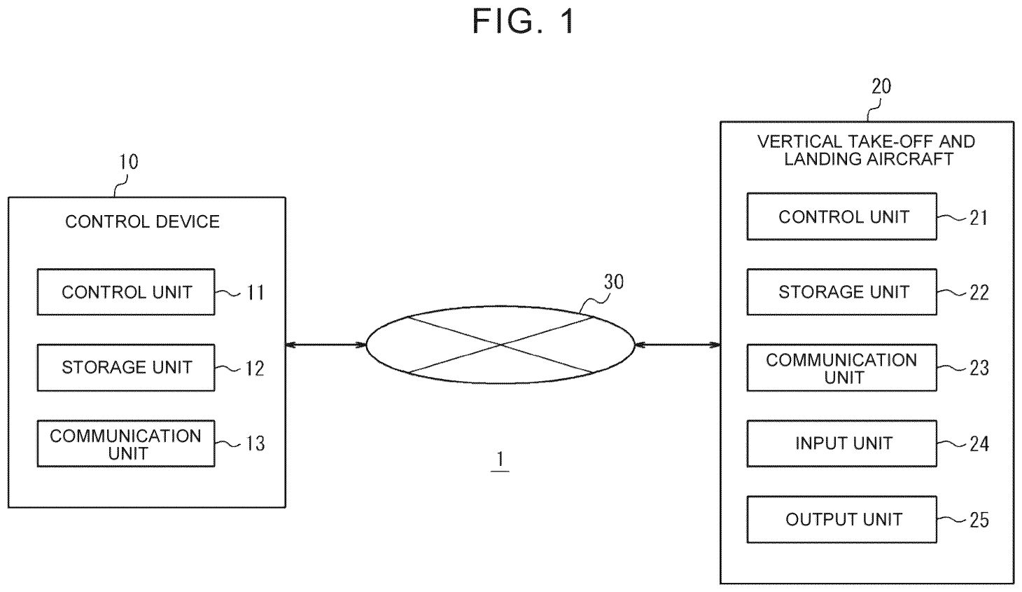

The configuration of a system 1 according to the present embodiment will be described with reference to FIG. 1. The system 1 includes a control device 10 and a vertical take-off and landing aircraft 20. The control device 10 can communicate with the vertical take-off and landing aircraft 20 via a network 30. Although only one vertical take-off and landing aircraft 20 is shown in FIG. 1, the number of vertical take-off and landing aircraft 20 in the system 1 is not limited to this.

The control device 10 is a computer installed in a facility such as a data center. The control device 10 is, for example, a server belonging to a cloud computing system or any other computing system. In the present embodiment, the control device 10 is operated by a business operator that manages a vertical landing field and a runway as landing locations for the vertical take-off and landing aircraft 20.

The vertical take-off and landing aircraft 20 includes an electric vertical take-off and landing aircraft (eVTOL). The vertical take-off and landing aircraft 20 may be manned or unmanned. In the case of a manned aircraft, the vertical take-off and landing aircraft 20 is piloted by a pilot. The vertical take-off and landing aircraft 20 may be movable by autopilot. When the vertical take-off and landing aircraft 20 includes fixed wings in addition to rotary wings, the aircraft can make a runway landing in addition to a vertical landing. In the present embodiment, the system 1 includes a plurality of vertical take-off and landing aircraft 20. The plurality of vertical take-off and landing aircraft 20 include a mixture of aircraft with fixed wings and aircraft without fixed wings.

The network 30 includes the Internet, at least one WAN, at least one MAN, or any combination thereof. The term “WAN” is an abbreviation for “wide area network.” The term “MAN” is an abbreviation for “metropolitan area network.” The network 30 may include at least one wireless network, at least one optical network, or any combination thereof. Examples of the wireless network include an ad hoc network, a cellular network, a wireless LAN, a satellite communication network, or a terrestrial microwave network. The term “LAN” is an abbreviation for “local area network.”

An overview of the present embodiment will be given first, and details of the present embodiment will be given later. When the control device 10 receives a landing request from the vertical take-off and landing aircraft 20, the control device 10 determines whether the vertical take-off and landing aircraft 20 is adapted to a runway landing. When the vertical take-off and landing aircraft 20 is adapted to the runway landing, the control device 10 acquires reference information indicating an environment for landing of the vertical take-off and landing aircraft 20. The control device 10 transmits an instruction to the vertical take-off and landing aircraft 20 to land in one landing mode out of the vertical landing and the runway landing based on the acquired reference information.

According to the present embodiment, the control device 10 determines the most appropriate landing mode depending on the situation and instructs the vertical take-off and landing aircraft 20, thereby enabling the vertical take-off and landing aircraft 20 to land safely. Thus, it is possible to improve the technology that allows the vertical take-off and landing aircraft adapted to a plurality of landing modes to land in a more appropriate landing mode depending on the situation when the aircraft makes a landing.

The configuration of the control device 10 according to the present embodiment will be described with reference to FIG. 1. The control device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a processor dedicated to specific processes. The term “CPU” is an abbreviation for “central processing unit.” The term “GPU” is an abbreviation for “graphics processing unit.” Examples of the programmable circuit include an FPGA. The term “FPGA” is an abbreviation for “field-programmable gate array.” Examples of the dedicated circuit include an ASIC. The term “ASIC” is an abbreviation for “application specific integrated circuit.” The control unit 11 executes processes related to an operation of the control device 10 while controlling each unit of the control device 10.

The storage unit 12 includes at least one semiconductor memory, at least one magnetic memory, at least one optical memory, or any combination thereof. Examples of the semiconductor memory include a RAM, a ROM, and a flash memory. The term “RAM” is an abbreviation for “random access memory.” The term “ROM” is an abbreviation for “read only memory.” Examples of the RAM include an SRAM and a DRAM. The term “SRAM” is an abbreviation for “static random access memory.” The term “DRAM” is an abbreviation for “dynamic random access memory.” Examples of the ROM include an EEPROM. The term “EEPROM” is an abbreviation for “electrically erasable programmable read only memory.” Examples of the flash memory include an SSD. The term “SSD” is an abbreviation for “solid-state drive.” Examples of the magnetic memory include an HDD. The term “HDD” is an abbreviation for “hard disk drive.” The storage unit 12 functions as, for example, a main storage device, an auxiliary storage device, or a cache memory. The storage unit 12 stores information to be used for the operation of the control device 10 and information obtained through the operation of the control device 10.

The communication unit 13 includes at least one communication module. The communication module is, for example, a module compatible with a wired LAN communication standard such as Ethernet (registered trademark) or a wireless LAN communication standard such as IEEE 802.11. The term “IEEE” is an abbreviation for “Institute of Electrical and Electronics Engineers.” The communication unit 13 communicates with devices other than the control device 10. The communication unit 13 receives information to be used for the operation of the control device 10 and transmits information obtained through the operation of the control device 10.

The configuration of the vertical take-off and landing aircraft 20 according to the present embodiment will be described with reference to FIG. 1. The vertical take-off and landing aircraft 20 includes a control unit 21, a storage unit 22, a communication unit 23, an input unit 24, and an output unit 25.

The control unit 21 includes at least one processor, at least one programmable circuit, at least one dedicated circuit, at least one ECU, or any combination thereof. The term “ECU” is an abbreviation for “electronic control unit.” The processor is a general-purpose processor such as a CPU or a GPU, or a processor dedicated to specific processes. Examples of the programmable circuit include an FPGA. Examples of the dedicated circuit include an ASIC. The control unit 21 executes processes related to an operation of the vertical take-off and landing aircraft 20 while controlling each unit of the vertical take-off and landing aircraft 20.

The storage unit 22 includes at least one semiconductor memory, at least one magnetic memory, at least one optical memory, or any combination thereof. Examples of the semiconductor memory include a RAM and a ROM. Examples of the RAM include an SRAM and a DRAM. Examples of the ROM include an EEPROM. The storage unit 22 functions as, for example, a main storage device, an auxiliary storage device, or a cache memory. The storage unit 22 stores data to be used for the operation of the vertical take-off and landing aircraft 20 and data obtained through the operation of the vertical take-off and landing aircraft 20.

The communication unit 23 includes at least one communication interface. Examples of the communication interface include an interface compatible with mobile communication standards such as LTE, 4G standards, or 5G standards, an interface compatible with short-range wireless communication such as Bluetooth (registered trademark), and a LAN interface. The term “LTE” is an abbreviation for “Long Term Evolution.” The term “4G” is an abbreviation for “fourth generation.” The term “5G” is an abbreviation for “fifth generation.” The communication unit 23 receives data to be used for the operation of the vertical take-off and landing aircraft 20 and transmits data obtained through the operation of the vertical take-off and landing aircraft 20.

The input unit 24 includes at least one input interface. Examples of the input interface include a physical key, a capacitive key, a pointing device, a touch screen integrated with a display, and a microphone. The input unit 24 receives an operation for inputting data to be used for the operation of the vertical take-off and landing aircraft 20. The input unit 24 may be connected to the vertical take-off and landing aircraft 20 as an external input device instead of being provided in the vertical take-off and landing aircraft 20. As a connection method, any method such as a USB, an HDMI (registered trademark), or Bluetooth (registered trademark) can be used. The term “USB” is an abbreviation for “universal serial bus.” The term “HDMI (registered trademark)” is an abbreviation for “high-definition multimedia interface.”

The output unit 25 includes at least one output interface. Examples of the output interface include a display and a loudspeaker. Examples of the display include an LCD and an organic EL display. The term “LCD” is an abbreviation for “liquid crystal display.” The term “EL” is an abbreviation for “electroluminescence.” The output unit 25 outputs data obtained through the operation of the vertical take-off and landing aircraft 20. The output unit 25 may be connected to the vertical take-off and landing aircraft 20 as an external output device instead of being provided in the vertical take-off and landing aircraft 20. As a connection method, any method such as a USB, an HDMI (registered trademark), or Bluetooth (registered trademark) can be used.

The functions of the control device 10 or the vertical take-off and landing aircraft 20 are implemented by executing a program according to the present embodiment on a processor serving as the control unit 11 or the control unit 21. That is, the functions of the control device 10 or the vertical take-off and landing aircraft 20 are implemented by software. The program causes the computer to execute the operation of the control device 10 or the vertical take-off and landing aircraft 20 such that the computer functions as the control device 10 or the vertical take-off and landing aircraft 20. That is, the computer functions as the control device 10 or the vertical take-off and landing aircraft 20 by executing the operation of the control device 10 or the vertical take-off and landing aircraft 20 in accordance with the program.

The program can be stored in a non-transitory computer-readable medium. Examples of the non-transitory computer-readable medium include a flash memory, a magnetic recording device, an optical disc, a magneto-optical recording medium, and a ROM. For example, the program is distributed by selling, transferring, or renting a portable medium storing the program, such as an SD card, a DVD, or a CD-ROM. The term “SD” is an abbreviation for “secure digital.” The term “DVD” is an abbreviation for “digital versatile disc.” The term “CD-ROM” is an abbreviation for “compact disc read only memory.” The program may be distributed by storing the program in a storage of a server and transferring the program from the server to other computers. The program may be provided as a program product.

For example, the computer temporarily stores the program stored in the portable medium or the program transferred from the server in the main storage device. The computer then causes the processor to read the program stored in the main storage device, and causes the processor to execute processes in accordance with the read program. The computer may read the program directly from the portable medium and execute the processes in accordance with the program. The computer may execute the processes in accordance with the received program every time the program is transferred from the server to the computer. The processes may be executed by a so-called ASP service in which the functions are implemented only by execution instructions and result acquisition without transferring the program from the server to the computer. The term “ASP” is an abbreviation for “application service provider.” The program includes information that is provided for processing by an electronic computer and equivalent to the program. For example, data that is not a direct command to the computer but has the property of defining the processing of the computer is the “information equivalent to the program.”

Part or all of the functions of the control device 10 or the vertical take-off and landing aircraft 20 may be implemented by a programmable circuit or a dedicated circuit serving as the control unit 11 or the control unit 21. That is, part or all of the functions of the control device 10 or the vertical take-off and landing aircraft 20 may be implemented by hardware.

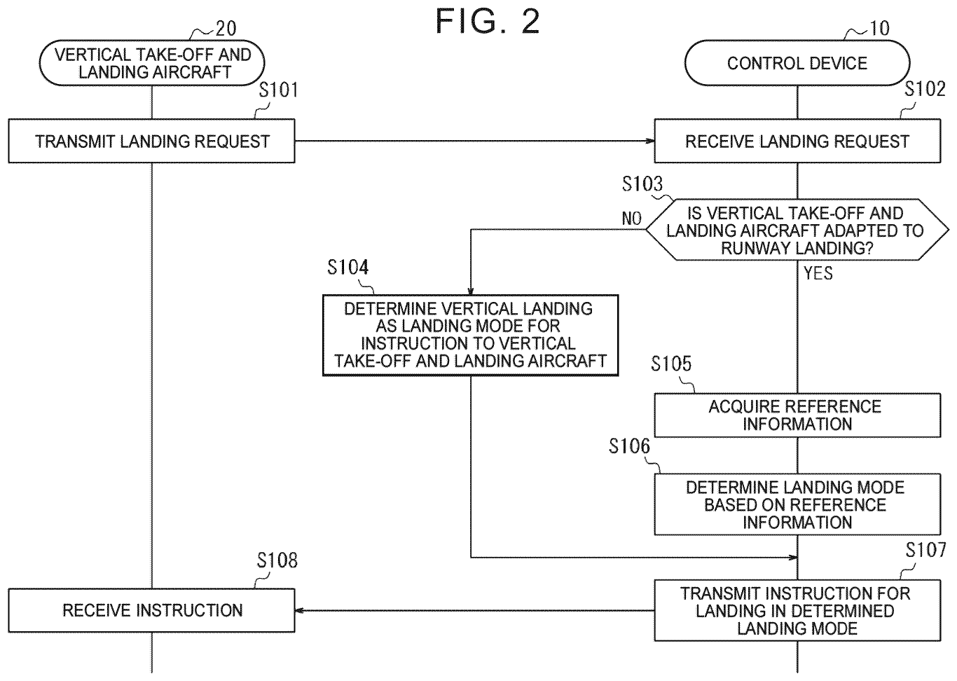

Operations of the system 1 according to the present embodiment will be described with reference to FIG. 2. Among the operations shown in FIG. 2, the operation of the control device 10 corresponds to the method according to the present embodiment. In the following description, it is assumed that communication between the control device 10 and an external device is performed via the communication unit 13 and the network 30 and communication between the vertical take-off and landing aircraft 20 and an external device is performed via the communication unit 23 and the network 30.

In S101 of FIG. 2, the control unit 21 of the vertical take-off and landing aircraft 20 transmits a landing request to the control device 10. The landing request may include an identifier for identifying a pilot, a scheduled landing time, etc.

In S102, the control unit 11 of the control device 10 acquires the landing request by receiving it from the vertical take-off and landing aircraft 20. The control unit 11 may communicate with a server device of any institution that receives a flight schedule etc. of the vertical take-off and landing aircraft 20, and receive information indicating that the vertical take-off and landing aircraft 20 will land from the server device as the landing request.

In S103, the control unit 11 determines whether the vertical take-off and landing aircraft 20 is adapted to the runway landing. When determination is made that the vertical take-off and landing aircraft 20 is adapted to the runway landing (S103: YES), the operation of the control unit 11 proceeds to S105. When determination is made that the vertical take-off and landing aircraft 20 is not adapted to the runway landing (S103: NO), the process of the control unit 11 proceeds to S104. For example, the control unit 11 receives information indicating the type of vertical take-off and landing aircraft 20 from the vertical take-off and landing aircraft 20. This information may be included in the landing request, or may be recorded in advance in a database in association with the identifier for identifying the pilot. The database may be stored in the storage unit 12. The control unit 11 may refer to information indicating, for each type of vertical take-off and landing aircraft 20, whether the vertical take-off and landing aircraft 20 includes fixed wings, and determine whether the vertical take-off and landing aircraft 20 is adapted to the runway landing based on that information. The information may be preset and stored in the storage unit 12. In this case, the control unit 11 determines that the vertical take-off and landing aircraft 20 is adapted to the runway landing when the vertical take-off and landing aircraft 20 includes fixed wings, and determines that the vertical take-off and landing aircraft 20 is not adapted to the runway landing when the vertical take-off and landing aircraft 20 does not include fixed wings.

The method is not limited to this, and any method may be used for the determination. The control unit 11 may receive an image showing the vertical take-off and landing aircraft 20 from an outdoor camera that captures an image of the vertical take-off and landing aircraft 20, and make analysis based on the image using any image analysis technology as to whether the vertical take-off and landing aircraft 20 includes fixed wings. In this case, the control unit 11 determines that the vertical take-off and landing aircraft 20 is adapted to the runway landing when the vertical take-off and landing aircraft 20 shown in the image includes fixed wings, and determines that the vertical take-off and landing aircraft 20 is not adapted to the runway landing when the vertical take-off and landing aircraft 20 shown in the image does not include fixed wings. The control unit 11 may receive, from the vertical take-off and landing aircraft 20, information indicating whether the vertical take-off and landing aircraft 20 is adapted to the runway landing, and determine whether the vertical take-off and landing aircraft 20 is adapted to the runway landing based on that information.

First, description will be given of the case where the control unit 11 determines in S103 that the vertical take-off and landing aircraft 20 is not adapted to the runway landing. In S104, the control unit 11 determines the vertical landing as the landing mode for instruction to the vertical take-off and landing aircraft 20. Then, the process of the control unit 11 proceeds to S107.

Next, description will be given of the case where the control unit 11 determines in S103 that the vertical take-off and landing aircraft 20 is adapted to the runway landing. In S105, the control unit 11 acquires reference information indicating an environment for landing of the vertical take-off and landing aircraft 20. The control unit 11 may acquire the reference information by reading the reference information preset and stored in the storage unit 12. The control unit 11 may acquire the reference information by receiving it from an external device.

The reference information may include congestion levels of the vertical landing field and the runway serving as the landing locations for the vertical take-off and landing aircraft 20. Specifically, the congestion level may be information indicating a level of congestion such as “high,” “medium,” or “low.” The congestion level may be information indicating whether the vertical landing field or the runway is available. The control unit 11 may communicate with a server device of any institution that receives flight schedules of flight vehicles including the vertical take-off and landing aircraft 20, and acquire information indicating the congestion levels as the reference information by receiving it from the server device. For example, the control unit 11 may receive images showing the vertical landing field and the runway from outdoor cameras, and analyze the congestion levels of the vertical landing field and the runway based on the images using any image analysis technology. Specifically, the control unit 11 analyzes the numbers of vehicles present on the vertical landing field and the runway based on the images. The vehicles include flight vehicles such as airplanes, helicopters, multicopters, and unmanned flight vehicles. The vehicles may include maintenance vehicles for the vertical landing field and the runway. The control unit 11 may generate reference information indicating that the congestion level is “low” when the number of vehicles is smaller than a first threshold, that the congestion level is “medium” when the number is equal to or larger than the first threshold and smaller than a second threshold, and that the congestion level is “high” when the number is equal to or larger than the second threshold. The first threshold and the second threshold may be stored in the storage unit 12.

When the landing request includes a scheduled landing time, the control unit 11 may acquire the reference information based on information indicating an expected congestion level at the scheduled landing time. Specifically, the control unit 11 reads, from the storage unit 12, information on a record of an average or median value of congestion levels on the same day of the week and in the same time frame in the past. The control unit 11 may generate reference information indicating that the congestion level is “low” when the average or median value is smaller than a first threshold, that the congestion level is “medium” when the average or median value is equal to or larger than the first threshold and smaller than a second threshold, and that the congestion level is “high” when the average or median value is equal to or larger than the second threshold.

The reference information may include experience amounts of the vertical landing and the runway landing for the pilot of the vertical take-off and landing aircraft 20. The experience amount may be the total number of times or the total amount of time the pilot has performed the vertical landing or the runway landing by piloting the vertical take-off and landing aircraft 20 or other flight vehicles. The control unit 11 may acquire the experience amount input by the pilot to the input unit 24 of the vertical take-off and landing aircraft 20 as the reference information by receiving it from the vertical take-off and landing aircraft 20. When the landing request includes the identifier of the pilot, the control unit 11 may acquire the experience amount of the pilot as the reference information by referring to a database in which the experience amount is recorded in association with the identifier. The database may be prestored in the storage unit 12.

The reference information may include weather conditions at the vertical landing field and the runway serving as the landing locations for the vertical take-off and landing aircraft 20. In this case, the reference information may include at least one of information on wind, information on rain or snow, and information on fog as the weather condition. The information on wind includes a wind volume, a wind speed, etc. The information on rain or snow includes a rainfall amount or a snowfall amount. The information on fog includes the level of fog (range and density of fog). The control unit 11 may communicate with a server device in a weather observation center etc., and acquire information indicating the weather conditions by receiving it as the reference information. The reference information is not limited to this, and may include information on the level of a dust storm, a sand storm, etc. as the weather condition. When the landing request includes a scheduled landing time, the reference information may include an expected weather condition at the scheduled landing time.

In S106, the control unit 11 determines, based on the reference information, one landing mode out of the vertical landing and the runway landing as the landing mode for instruction to the vertical take-off and landing aircraft 20.

For example, when the reference information includes the congestion levels of the vertical landing field and the runway, the control unit 11 determines a landing mode associated with a landing location having a lower congestion level as the landing mode for instruction to the vertical take-off and landing aircraft 20. Thus, the vertical take-off and landing aircraft 20 can automatically be instructed to adopt a landing mode in which the congestion level is lower and the vertical take-off and landing aircraft 20 can land safely.

For example, when the reference information includes the experience amounts of the vertical landing and the runway landing for the pilot of the vertical take-off and landing aircraft 20, the control unit 11 determines a landing mode having a larger experience amount as the landing mode for instruction to the vertical take-off and landing aircraft 20. Thus, the vertical take-off and landing aircraft 20 can automatically be instructed to adopt a landing mode in which the pilot's experience amount is larger and the pilot is skilled.

For example, when the reference information includes the information on wind as the weather condition and there is a predetermined value or more of the wind speed of tailwind or crosswind relative to the direction in which the vertical take-off and landing aircraft 20 approaches the runway, the control unit 11 determines the vertical landing as the landing mode for instruction to the vertical take-off and landing aircraft 20. Thus, the vertical take-off and landing aircraft 20 can automatically be instructed to adopt the vertical landing in the bad weather condition that makes it difficult to control the runway landing because of the strong tailwind or crosswind.

For example, when the reference information includes the information on rain or snow as the weather condition and there is a predetermined amount or more of rainfall or snowfall on the runway, the control unit 11 determines the vertical landing as the landing mode for instruction to the vertical take-off and landing aircraft 20. Thus, the vertical take-off and landing aircraft 20 can automatically be instructed to adopt the vertical landing in the bad weather condition unsuitable for the runway landing because the visibility is impaired due to the rainfall or snowfall.

For example, when the reference information includes the information on fog as the weather condition and at least one of the range and the density of fog at the runway is equal to or larger than a predetermined value, the control unit 11 determines the vertical landing as the landing mode for instruction to the vertical take-off and landing aircraft 20. Thus, the vertical take-off and landing aircraft 20 can automatically be instructed to adopt the vertical landing in the bad weather condition unsuitable for the runway landing because the visibility is impaired due to the fog.

The control unit 11 may determine a landing mode that is more suitable for the weather condition indicated by the reference information out of the vertical landing and the runway landing. For example, when the reference information includes the information on the level of a dust storm, a sand storm, etc. as the weather condition and the level of the dust storm, the sand storm, etc. is equal to or higher than a predetermined level, the vertical landing is determined as the landing mode for instruction to the vertical take-off and landing aircraft 20. The information indicating the predetermined level may be preset and stored in the storage unit 12.

For example, when the reference information includes a plurality of pieces of information on the environment for landing of the vertical take-off and landing aircraft 20, the control unit 11 may determine the landing mode based on preset priority levels of the pieces of information. For example, it is assumed that the reference information includes the congestion levels, the weather conditions, and the pilot's experience amounts, the congestion levels are “high” for the vertical landing field and “low” for the runway, and the weather conditions include a predetermined amount or more of rainfall. It is assumed that the total number of landings serving as the pilot's experience amount is larger for the vertical landing than for the runway landing. It is assumed that higher priority levels are set in the order of the congestion level, the weather condition, and the pilot's experience amount. In this case, the control unit 11 may determine the runway landing as the landing mode for instruction to the vertical take-off and landing aircraft 20 based on the congestion levels having the highest priority level.

For example, when a preset priority threshold is exceeded for each of the pieces of information included in the reference information, the control unit 11 may dynamically set the priority level again so that the priority level becomes highest. For example, it is assumed that higher priority levels are set in the order of the congestion level, the weather condition, and the pilot's experience amount and the priority threshold for the rainfall amount serving as the weather condition is set to X [mm/h]. When the rainfall amount indicated by the acquired reference information is equal to or larger than the priority threshold X, the control unit 11 may set the priority levels of the information again to become higher in the order of the weather condition, the congestion level, and the pilot's experience amount, and determine the vertical landing as the landing mode for instruction to the vertical take-off and landing aircraft 20 based on the weather conditions having the highest priority level.

In S107, the control unit 11 transmits an instruction to the vertical take-off and landing aircraft 20 to land in the landing mode determined in S104 or S106. Specifically, the control unit 11 transmits a signal to the vertical take-off and landing aircraft 20 to instruct it to land in the determined landing mode.

As shown in S105 to S107, the control unit 11 transmits an instruction to the vertical take-off and landing aircraft 20 to land in one landing mode out of the vertical landing and the runway landing based on the acquired reference information.

The control unit 11 may update the pilot's experience amount of the vertical landing or the runway landing indicated by the reference information based on the landing mode in the instruction. For example, the control unit 11 may update the reference information by incrementing the number of experiences by one for the landing mode in the instruction out of the vertical landing and the runway landing, and store the updated reference information in the storage unit 12.

In S108, the control unit 21 of the vertical take-off and landing aircraft 20 receives the instruction from the control device 10. The control unit 21 controls each unit of the vertical take-off and landing aircraft 20 to land on the vertical landing field when the received instruction signal indicates an instruction for the vertical landing, and to land on the runway when the signal indicates an instruction for the runway landing. Then, the operations of the system 1 end.

The landing of the vertical take-off and landing aircraft 20 may be controlled mainly by the control unit 11 of the control device 10. In this case, the control unit 11 may transmit a signal to the vertical take-off and landing aircraft 20 to control each unit of the vertical take-off and landing aircraft 20, in addition to the instruction signal for landing in one landing mode out of the vertical landing and the runway landing.

The present disclosure is not limited to the embodiment described above. For example, two or more blocks in the block diagram may be integrated, or a single block may be divided apart. Two or more steps in the flowchart may be executed in parallel or in different order as necessary or based on processing capacities of devices that execute the steps, instead of being executed in time series in accordance with description. Other modifications may be made without departing from the gist of the present disclosure.

As a modification of the present embodiment, the control unit 11 determines one take-off mode out of a vertical take-off and a runway take-off, and transmits an instruction to the vertical take-off and landing aircraft 20 to take off in the determined take-off mode.

The configuration of the system 1 according to the present modification is similar to that in the above embodiment, and therefore description thereof will be omitted. The configurations of the control device 10 and the vertical take-off and landing aircraft 20 according to the present modification are similar to those in the above embodiment, and therefore description thereof will be omitted.

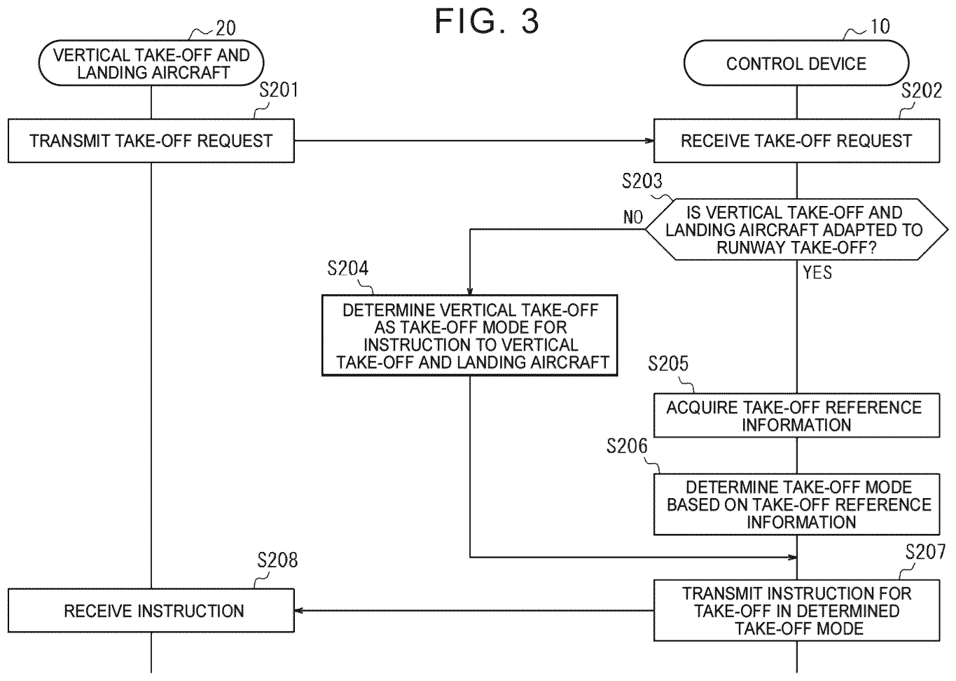

Operations of the system 1 according to the present modification will be described below with reference to FIG. 3.

In S201, the control unit 21 of the vertical take-off and landing aircraft 20 transmits a take-off request to the control device 10. The take-off request may include an identifier for identifying a pilot, a scheduled take-off time, etc.

In S202, the control unit 11 of the control device 10 acquires the take-off request by receiving it from the vertical take-off and landing aircraft 20. The control unit 11 may communicate with a server device of any institution that receives a flight schedule etc. of the vertical take-off and landing aircraft 20, and receive information indicating that the vertical take-off and landing aircraft 20 will take off from the server device as the take-off request.

In S203, the control unit 11 determines whether the vertical take-off and landing aircraft 20 is adapted to the runway take-off. When determination is made that the vertical take-off and landing aircraft 20 is adapted to the runway take-off (S203: YES), the operation of the control unit 11 proceeds to S205. When determination is made that the vertical take-off and landing aircraft 20 is not adapted to the runway take-off (S203: NO), the process of the control unit 11 proceeds to S204. As in the above embodiment, the control unit 11 may refer to information indicating, for each type of vertical take-off and landing aircraft 20, whether the vertical take-off and landing aircraft 20 includes fixed wings, and determine whether the vertical take-off and landing aircraft 20 is adapted to the runway take-off based on that information. As in the above embodiment, the control unit 11 may determine whether the vertical take-off and landing aircraft 20 is adapted to the runway take-off based on an image captured by an outdoor camera that captures an image of the vertical take-off and landing aircraft 20. As in the above embodiment, the control unit 11 may receive, from the vertical take-off and landing aircraft 20, information indicating whether the vertical take-off and landing aircraft 20 is adapted to the runway take-off, and determine whether the vertical take-off and landing aircraft 20 is adapted to the runway take-off based on that information.

First, description will be given of the case where the control unit 11 determines in S203 that the vertical take-off and landing aircraft 20 is not adapted to the runway take-off. In S204, the control unit 11 determines the vertical take-off as the take-off mode for instruction to the vertical take-off and landing aircraft 20. Then, the process of the control unit 11 proceeds to S207.

Next, description will be given of the case where the control unit 11 determines in S203 that the vertical take-off and landing aircraft 20 is adapted to the runway take-off. In S205, the control unit 11 acquires take-off reference information indicating an environment for take-off of the vertical take-off and landing aircraft. The control unit 11 may acquire the take-off reference information by reading the take-off reference information preset and stored in the storage unit 12. The control unit 11 may acquire the take-off reference information by receiving it from an external device.

Similarly to the reference information according to the above embodiment, the take-off reference information may include congestion levels of a vertical take-off field and a runway serving as take-off locations for the vertical take-off and landing aircraft 20. Specifically, the congestion level may be information indicating a level of congestion such as “high,” “medium,” or “low.” The control unit 11 may communicate with a server device of, for example, any institution that receives flight schedules of flight vehicles, and acquire information indicating the congestion levels as the reference information by receiving it. For example, the control unit 11 may receive images showing the vertical take-off field and the runway from outdoor cameras, and analyze the congestion levels of the vertical take-off field and the runway based on the images using any image analysis technology. For example, when the take-off request includes a scheduled take-off time, the control unit 11 may acquire the take-off reference information based on information indicating an expected congestion level at the scheduled take-off time.

Similarly to the reference information according to the above embodiment, the take-off reference information may include experience amounts of the vertical take-off and the runway take-off for the pilot of the vertical take-off and landing aircraft 20. The control unit 11 may acquire the experience amount input by the pilot to the input unit 24 of the vertical take-off and landing aircraft 20 as the reference information by receiving it from the vertical take-off and landing aircraft 20. When the take-off request includes the identifier of the pilot, the control unit 11 may acquire the experience amount of the pilot as the reference information by referring to a database in which the experience amount is recorded in association with the identifier. The database may be prestored in the storage unit 12.

Similarly to the reference information according to the above embodiment, the take-off reference information may include weather conditions at the vertical take-off field and the runway serving as the take-off locations for the vertical take-off and landing aircraft 20. In this case, the reference information may include at least one of information on wind, information on rain or snow, and information on fog as the weather condition. When the take-off request includes a scheduled take-off time, the take-off reference information may include an expected weather condition at the scheduled take-off time.

In S206, the control unit 11 determines, based on the take-off reference information, one take-off mode out of the vertical take-off and the runway take-off as the take-off mode for instruction to the vertical take-off and landing aircraft 20.

For example, when the take-off reference information includes the congestion levels of the vertical take-off field and the runway, the control unit 11 determines a take-off mode associated with a take-off location having a lower congestion level as the take-off mode for instruction to the vertical take-off and landing aircraft 20. For example, when the take-off reference information includes the experience amounts of the vertical take-off and the runway take-off for the pilot of the vertical take-off and landing aircraft 20, the control unit 11 determines a take-off mode having a larger experience amount as the take-off mode for instruction to the vertical take-off and landing aircraft 20. For example, when the take-off reference information includes the information on wind as the weather condition and the wind speed of a tailwind or crosswind relative to the direction in which the vertical take-off and landing aircraft 20 departs from the runway is equal to or larger than a predetermined amount, the control unit 11 determines the vertical take-off as the take-off mode for instruction to the vertical take-off and landing aircraft 20. For example, when the take-off reference information includes the information on rain or snow as the weather condition and there is a predetermined amount or more of rainfall or snowfall on the runway, the control unit 11 determines the vertical take-off as the take-off mode for instruction to the vertical take-off and landing aircraft 20. For example, when the take-off reference information includes the information on fog as the weather condition and at least one of the range and the density of fog at the runway is equal to or larger than a predetermined value, the control unit 11 determines the vertical take-off as the take-off mode for instruction to the vertical take-off and landing aircraft 20.

As in the above embodiment, when the take-off reference information includes a plurality of pieces of information on the environment for take-off of the vertical take-off and landing aircraft 20, the control unit 11 may determine the take-off mode based on preset priority levels of the pieces of information. As in the above embodiment, when a preset priority threshold is exceeded for each of the pieces of information included in the take-off reference information, the control unit 11 may dynamically set the priority level of the information again so that the priority level becomes highest.

In S207, the control unit 11 transmits an instruction to the vertical take-off and landing aircraft 20 to take off in the take-off mode determined in S204 or S206. The control unit 11 may update the pilot's experience amount of the vertical take-off or the runway take-off included in the take-off reference information based on the take-off mode in the instruction. For example, the control unit 11 may update the take-off reference information by incrementing the number of experiences by one for the take-off mode in the instruction out of the vertical take-off and the runway take-off, and store the updated take-off reference information in the storage unit 12.

In S208, the control unit 21 of the vertical take-off and landing aircraft 20 receives the instruction from the control device 10. The control unit 21 controls each unit of the vertical take-off and landing aircraft 20 to take off from the vertical take-off field when the received instruction signal indicates an instruction for the vertical take-off, and to take off from the runway when the signal indicates an instruction for the runway take-off. Then, the operations of the system 1 end.

The take-off of the vertical take-off and landing aircraft 20 may be controlled mainly by the control unit 11 of the control device 10. In this case, the control unit 11 may transmit a signal to the vertical take-off and landing aircraft 20 to control each unit of the vertical take-off and landing aircraft 20, in addition to the instruction signal for take-off in one take-off mode out of the vertical take-off and the runway take-off.

Part of the embodiment of the present disclosure is shown as an example below. However, the embodiment of the present disclosure is not limited thereto.

### Appendix 1

A control device including a storage unit, a communication unit configured to communicate with a vertical take-off and landing aircraft, and a control unit, in which the control unit is configured to: when a landing request is received from the vertical take-off and landing aircraft via the communication unit, determine whether the vertical take-off and landing aircraft is adapted to a runway landing; and when the vertical take-off and landing aircraft is adapted to the runway landing, acquire reference information indicating an environment for landing of the vertical take-off and landing aircraft, and transmit an instruction to the vertical take-off and landing aircraft to land in one landing mode out of a vertical landing and the runway landing based on the reference information.

### Appendix 2

The control device according to appendix 1, in which: the reference information includes congestion levels of a vertical landing field and a runway serving as landing locations for the vertical take-off and landing aircraft; and the control unit is configured to transmit an instruction to the vertical take-off and landing aircraft to land in the landing mode associated with the landing location where the congestion level is lower between the vertical landing field and the runway.

### Appendix 3

The control device according to appendix 1 or 2, in which: the reference information includes experience amounts of the vertical landing and the runway landing for a pilot of the vertical take-off and landing aircraft; and the control unit is configured to transmit an instruction to the vertical take-off and landing aircraft to land in the landing mode in which the experience amount is larger between the vertical landing and the runway landing.

### Appendix 4

The control device according to any one of appendices 1 to 3, in which: the reference information includes weather conditions at a vertical landing field and a runway serving as landing locations for the vertical take-off and landing aircraft; and the control unit is configured to transmit an instruction to the vertical take-off and landing aircraft to land in the landing mode that is more suitable, between a vertical landing and the runway landing, for landing under the weather condition.

### Appendix 5

The control device according to appendix 4, in which: the reference information includes information on wind as the weather condition; and the control unit is configured to, when a wind speed of a tailwind or a crosswind relative to a direction in which the vertical take-off and landing aircraft approaches the runway is equal to or higher than a predetermined value, transmit an instruction to the vertical take-off and landing aircraft to land by the vertical landing.

### Appendix 6

The control device according to appendix 4 or 5, in which: the reference information includes information on rain or snow as the weather condition; and the control unit is configured to, when a rainfall amount or a snowfall amount at the runway is equal to or larger than a predetermined amount, transmit an instruction to the vertical take-off and landing aircraft to land by the vertical landing.

### Appendix 7

The control device according to any one of appendices 4 to 6, in which: the reference information includes information on fog as the weather condition; and the control unit is configured to, when at least one of a range and a density of fog at the runway is equal to or larger than a predetermined value, transmit an instruction to the vertical take-off and landing aircraft to land by the vertical landing.

### Appendix 8

The control device according to any one of appendices 1 to 7, in which the control unit is configured to: when a take-off request is received from the vertical take-off and landing aircraft via the communication unit, determine whether the vertical take-off and landing aircraft is adapted to a runway take-off; and when the vertical take-off and landing aircraft is adapted to the runway take-off, acquire take-off reference information indicating an environment for take-off of the vertical take-off and landing aircraft, and transmit an instruction to the vertical take-off and landing aircraft to take off in one take-off mode out of a vertical take-off and the runway take-off based on the take-off reference information.

### Appendix 9

A method to be executed by a control device including a storage unit, a communication unit configured to communicate with a vertical take-off and landing aircraft, and a control unit, the method including: when a landing request is received from the vertical take-off and landing aircraft via the communication unit, determining, by the control unit, whether the vertical take-off and landing aircraft is adapted to a runway landing; and when the vertical take-off and landing aircraft is adapted to the runway landing, acquiring, by the control unit, reference information indicating an environment for landing of the vertical take-off and landing aircraft, and transmitting an instruction to the vertical take-off and landing aircraft to land in one landing mode out of a vertical landing and the runway landing based on the reference information.

### Appendix 10

The method according to appendix 9, in which: the reference information includes congestion levels of a vertical landing field and a runway serving as landing locations for the vertical take-off and landing aircraft; and the method further includes transmitting, by the control unit, an instruction to the vertical take-off and landing aircraft to land in the landing mode associated with the landing location where the congestion level is lower between the vertical landing field and the runway.

### Appendix 11

The method according to appendix 9 or 10, in which: the reference information includes experience amounts of the vertical landing and the runway landing for a pilot of the vertical take-off and landing aircraft; and the method further includes transmitting, by the control unit, an instruction to the vertical take-off and landing aircraft to land in the landing mode in which the experience amount is larger between the vertical landing and the runway landing.

### Appendix 12

The method according to any one of appendices 9 to 11, in which: the reference information includes weather conditions at a vertical landing field and a runway serving as landing locations for the vertical take-off and landing aircraft; and the method further includes transmitting, by the control unit, an instruction to the vertical take-off and landing aircraft to land in the landing mode that is more suitable, between a vertical landing and the runway landing, for landing under the weather condition.

### Appendix 13

The method according to appendix 12, in which: the reference information includes information on wind as the weather condition; and the method further includes, when a wind speed of a tailwind or a crosswind relative to a direction in which the vertical take-off and landing aircraft approaches the runway is equal to or higher than a predetermined value, transmitting, by the control unit, an instruction to the vertical take-off and landing aircraft to land by the vertical landing.

### Appendix 14

The method according to appendix 12 or 13, in which: the reference information includes information on rain or snow as the weather condition; and the method further includes, when a rainfall amount or a snowfall amount at the runway is equal to or larger than a predetermined amount, transmitting, by the control unit, an instruction to the vertical take-off and landing aircraft to land by the vertical landing.

### Appendix 15

The method according to any one of appendices 12 to 14, in which: the reference information includes information on fog as the weather condition; and the method further includes, when at least one of a range and a density of fog at the runway is equal to or larger than a predetermined value, transmitting, by the control unit, an instruction to the vertical take-off and landing aircraft to land by the vertical landing.

### Appendix 16

The method according to any one of appendices 9 to 15, further including: when a take-off request is received from the vertical take-off and landing aircraft via the communication unit, determining, by the control unit, whether the vertical take-off and landing aircraft is adapted to a runway take-off; and when the vertical take-off and landing aircraft is adapted to the runway take-off, acquiring, by the control unit, take-off reference information indicating an environment for take-off of the vertical take-off and landing aircraft, and transmitting an instruction to the vertical take-off and landing aircraft to take off in one take-off mode out of a vertical take-off and the runway take-off based on the take-off reference information.

### Appendix 17

A program causing a computer serving as a control device including a storage unit, a communication unit configured to communicate with a vertical take-off and landing aircraft, and a control unit to execute operations including: when a landing request is received from the vertical take-off and landing aircraft via the communication unit, determining whether the vertical take-off and landing aircraft is adapted to a runway landing; when the vertical take-off and landing aircraft is adapted to the runway landing, acquiring reference information indicating an environment for landing of the vertical take-off and landing aircraft, and transmitting an instruction to the vertical take-off and landing aircraft to land in one landing mode out of a vertical landing and the runway landing based on the reference information.

### Appendix 18

The program according to appendix 17, in which: the reference information includes congestion levels of a vertical landing field and a runway serving as landing locations for the vertical take-off and landing aircraft; and the operations further include transmitting an instruction to the vertical take-off and landing aircraft to land in the landing mode associated with the landing location where the congestion level is lower between the vertical landing field and the runway.

### Appendix 19

The program according to appendix 17 or 18, in which: the reference information includes experience amounts of the vertical landing and the runway landing for a pilot of the vertical take-off and landing aircraft; and the operations further include transmitting an instruction to the vertical take-off and landing aircraft to land in the landing mode in which the experience amount is larger between the vertical landing and the runway landing.

### Appendix 20

The program according to any one of appendices 17 to 19, in which: the reference information includes weather conditions at a vertical landing field and a runway serving as landing locations for the vertical take-off and landing aircraft; and the operations further include transmitting an instruction to the vertical take-off and landing aircraft to land in the landing mode that is more suitable, between a vertical landing and the runway landing, for landing under the weather condition.

What is claimed is:

1. A control device comprising a storage unit, a communication unit configured to communicate with a vertical take-off and landing aircraft, and a control unit, wherein the control unit is configured to:
when a landing request is received from the vertical take-off and landing aircraft via the communication unit, determine whether the vertical take-off and landing aircraft is adapted to a runway landing; and
when the vertical take-off and landing aircraft is adapted to the runway landing, acquire reference information indicating an environment for landing of the vertical take-off and landing aircraft, and transmit an instruction to the vertical take-off and landing aircraft to land in one landing mode out of a vertical landing and the runway landing based on the acquired reference information.

2. The control device according to claim 1, wherein:
the reference information includes congestion levels of a vertical landing field and a runway serving as landing locations for the vertical take-off and landing aircraft; and
the control unit is configured to transmit the instruction to the vertical take-off and landing aircraft to land in the landing mode associated with the landing location where the congestion level is lower between the vertical landing field and the runway.

3. The control device according to claim 1, wherein:
the reference information includes experience amounts of the vertical landing and the runway landing for a pilot of the vertical take-off and landing aircraft; and
the control unit is configured to transmit the instruction to the vertical take-off and landing aircraft to land in the landing mode in which the experience amount is larger between the vertical landing and the runway landing.

4. The control device according to claim 1, wherein:
the reference information includes weather conditions at a vertical landing field and a runway serving as landing locations for the vertical take-off and landing aircraft; and
the control unit is configured to transmit the instruction to the vertical take-off and landing aircraft to land in the landing mode that is more suitable, between a vertical landing and the runway landing, for landing under the weather condition.

5. The control device according to claim 4, wherein:
the reference information includes information on wind as the weather condition; and
the control unit is configured to, when a wind speed of a tailwind or a crosswind relative to a direction in which the vertical take-off and landing aircraft approaches the runway is equal to or higher than a predetermined value, transmit the instruction to the vertical take-off and landing aircraft to land by the vertical landing.

6. The control device according to claim 4, wherein:
the reference information includes information on rain or snow as the weather condition; and
the control unit is configured to, when a rainfall amount or a snowfall amount at the runway is equal to or larger than a predetermined amount, transmit the instruction to the vertical take-off and landing aircraft to land by the vertical landing.

7. The control device according to claim 4, wherein:
the reference information includes information on fog as the weather condition; and
the control unit is configured to, when at least one of a range and a density of fog at the runway is equal to or larger than a predetermined value, transmit the instruction to the vertical take-off and landing aircraft to land by the vertical landing.

8. The control device according to claim 1, wherein the control unit is configured to:
when a take-off request is received from the vertical take-off and landing aircraft via the communication unit, determine whether the vertical take-off and landing aircraft is adapted to a runway take-off; and
when the vertical take-off and landing aircraft is adapted to the runway take-off, acquire take-off reference information indicating an environment for take-off of the vertical take-off and landing aircraft, and transmit the instruction to the vertical take-off and landing aircraft to take off in one take-off mode out of a vertical take-off and the runway take-off based on the take-off reference information.

9. A method to be executed by a control device including a storage unit, a communication unit configured to communicate with a vertical take-off and landing aircraft, and a control unit, the method comprising:
when a landing request is received from the vertical take-off and landing aircraft via the communication unit, determining, by the control unit, whether the vertical take-off and landing aircraft is adapted to a runway landing; and
when the vertical take-off and landing aircraft is adapted to the runway landing, acquiring, by the control unit, reference information indicating an environment for landing of the vertical take-off and landing aircraft, and transmitting an instruction to the vertical take-off and landing aircraft to land in one landing mode out of a vertical landing and the runway landing based on the reference information.

10. The method according to claim 9, wherein:
the reference information includes congestion levels of a vertical landing field and a runway serving as landing locations for the vertical take-off and landing aircraft; and
the method further includes transmitting, by the control unit, the instruction to the vertical take-off and landing aircraft to land in the landing mode associated with the landing location where the congestion level is lower between the vertical landing field and the runway.

11. The method according to claim 9, wherein:
the reference information includes experience amounts of the vertical landing and the runway landing for a pilot of the vertical take-off and landing aircraft; and
the method further includes transmitting, by the control unit, the instruction to the vertical take-off and landing aircraft to land in the landing mode in which the experience amount is larger between the vertical landing and the runway landing.

12. The method according to claim 9, wherein:
the reference information includes weather conditions at a vertical landing field and a runway serving as landing locations for the vertical take-off and landing aircraft; and
the method further includes transmitting, by the control unit, the instruction to the vertical take-off and landing aircraft to land in the landing mode that is more suitable, between a vertical landing and the runway landing, for landing under the weather condition.

13. The method according to claim 12, wherein:
the reference information includes information on wind as the weather condition; and
the method further includes, when a wind speed of a tailwind or a crosswind relative to a direction in which the vertical take-off and landing aircraft approaches the runway is equal to or higher than a predetermined value, transmitting, by the control unit, the instruction to the vertical take-off and landing aircraft to land by the vertical landing.

14. The method according to claim 12, wherein:
the reference information includes information on rain or snow as the weather condition; and
the method further includes, when a rainfall amount or a snowfall amount at the runway is equal to or larger than a predetermined amount, transmitting, by the control unit, the instruction to the vertical take-off and landing aircraft to land by the vertical landing.

15. The method according to claim 12, wherein:
the reference information includes information on fog as the weather condition; and
the method further includes, when at least one of a range and a density of fog at the runway is equal to or larger than a predetermined value, transmitting, by the control unit, the instruction to the vertical take-off and landing aircraft to land by the vertical landing.

16. The method according to claim 9, further comprising:
when a take-off request is received from the vertical take-off and landing aircraft via the communication unit, determining, by the control unit, whether the vertical take-off and landing aircraft is adapted to a runway take-off; and
when the vertical take-off and landing aircraft is adapted to the runway take-off, acquiring, by the control unit, take-off reference information indicating an environment for take-off of the vertical take-off and landing aircraft, and transmitting the instruction to the vertical take-off and landing aircraft to take off in one take-off mode out of a vertical take-off and the runway take-off based on the acquired take-off reference information.

17. A non-transitory storage medium storing instructions that are executable by one or more processors and that cause the one or more processors to perform functions comprising:
when a landing request is received from a vertical take-off and landing aircraft via a communication unit, determining whether the vertical take-off and landing aircraft is adapted to a runway landing;
when the vertical take-off and landing aircraft is adapted to the runway landing, acquiring reference information indicating an environment for landing of the vertical take-off and landing aircraft; and
transmitting an instruction to the vertical take-off and landing aircraft to land in one landing mode out of a vertical landing and the runway landing based on the acquired reference information.

18. The non-transitory storage medium according to claim 17, wherein:
the reference information includes congestion levels of a vertical landing field and a runway serving as landing locations for the vertical take-off and landing aircraft; and
the functions further include transmitting the instruction to the vertical take-off and landing aircraft to land in the landing mode associated with the landing location where the congestion level is lower between the vertical landing field and the runway.

19. The non-transitory storage medium according to claim 17, wherein:
the reference information includes experience amounts of the vertical landing and the runway landing for a pilot of the vertical take-off and landing aircraft; and
the functions further include transmitting the instruction to the vertical take-off and landing aircraft to land in the landing mode in which the experience amount is larger between the vertical landing and the runway landing.

20. The non-transitory storage medium according to claim 17, wherein:
the reference information includes weather conditions at a vertical landing field and a runway serving as landing locations for the vertical take-off and landing aircraft; and
the functions further include transmitting the instruction to the vertical take-off and landing aircraft to land in the landing mode that is more suitable, between a vertical landing and the runway landing, for landing under the weather condition.
